(19) United States
(12) Patent Application Publication
(10) Pub. No.: US 2026/0170747 A1
(43) Pub. Date: Jun. 18, 2026

(54) TEXTURING METHOD FOR GENERATING 3D VIRTUAL MODEL AND COMPUTING DEVICE THEREFOR

(71) Applicant: 3I INC., Daegu (KR)

(72) Inventors: Ken KIM, Seoul (KR); Ji Wuck JUNG, Goyang-si (KR); Song Eun KIM, Seoul (KR)

(73) Assignee: 3I INC., Daegu (KR)

(21) Appl. No.: 19/430,890

(22) Filed: Dec. 23, 2025

Related U.S. Application Data
(63) Continuation of application No. PCT/KR2024/097161, filed on Dec. 19, 2024.

(30) Foreign Application Priority Data
Dec. 16, 2024 (KR) 10-2024-0187106

(51) Int. Cl. G06T 15/04; G06T 17/20; G06V 10/26; G06V 10/82

(52) U.S. Cl. CPC G06T 15/04; G06T 17/20; G06V 10/26; G06V 10/82; G06V 2201/07

(57) ABSTRACT

A texturing method for generating a 3D virtual model according to an embodiment of the present disclosure is performed in a computing device that generates a 3D virtual model for a real space based on a plurality of data sets respectively generated at a plurality of photographing points of the real space, and includes: generating a 3D mesh model for the real space using the plurality of data sets; selecting a texturing image based on the presence of a non-target object from the plurality of data sets and performing texturing on the 3D mesh model using the selected texturing image; and providing the textured 3D virtual model to a user through a user interface.

### CROSS-REFERENCE TO RELATED APPLICATION

This application claims priority from Korean Patent Application Nos. 10-2024-0187106, filed on Dec. 16, 2024, and PCT/KR2024/097161, filed on Dec. 19, 2024, in the Korean Intellectual Property Office, and all the benefits accruing therefrom under 35 U.S.C. 119. The contents of each of the above applications are incorporated herein in their entirety by reference.

### 1. FIELD

The present invention relates to a texturing method for generating a three-dimensional virtual model for a real space and a computing device therefor.

### 2. DESCRIPTION OF RELATED ART

In recent years, by receiving an online virtual space corresponding to a real space, a virtual space implementation technology that enables a user to experience as if they are in a real space without directly visiting the real space is being developed. Such real space-based virtual technology is a technology for implementing a digital twin, and various developments are being made.

In order to implement a virtual space based on a real space, it is necessary to obtain an image captured for a real space to be implemented and to provide a virtual space by generating a three-dimensional virtual image, that is, a three-dimensional virtual model based on this.

Such a three-dimensional virtual model is generated based on data captured at various points in real space. For example, in order to construct a 3D virtual model, data may be collected from various points in an actual reality space, and a 3D virtual model may be generated based on the collected data.

However, when data on such a real space is collected, there is a problem in that unwanted objects are reflected. For example, when data is collected inside a factory facility, when a passerby or the like is captured, there is a problem in that the passerby is reflected in an image or the like, and the shape of the person is textured in the 3D virtual model.

### SUMMARY

An aspect of the present disclosure is to solve the above-described problems, and an object of the present disclosure is to provide a texturing technique for generating a 3D virtual model, which may prevent a non-target object, which is an unintended subject, from being textured in advance when generating a 3D virtual space corresponding to a real space based on a photographing data set collected at various photographing points in the real space.

An object of the present application is to provide a texturing technology for generating a three-dimensional virtual model, which can efficiently select a texturing image without a non-target object with a small amount of computation by identifying a non-target object as an object identification target for an image and setting color data for an object region of the non-target object by replacing a padding value.

One technical aspect of the present application is to provide a texturing technique for generating a three-dimensional virtual model, capable of efficiently selecting an optimal texturing image even when a plurality of non-target objects exist, by setting a padding value as a penalty for color data of an object region of the non-target object.

However, the problems to be solved in the present disclosure are not limited to the above-mentioned problems, and may be variously expanded within the scope of the spirit and the scope of the present disclosure.

One technical aspect of the present invention proposes a texturing method for generating a three-dimensional virtual model. The texturing method for generating a three-dimensional virtual model is performed in a computing device which generates a three-dimensional virtual model for a real space on the basis of a plurality of data sets respectively generated at a plurality of photographing points of the real space, and comprises the steps of: generating a three-dimensional mesh model for the real space by using the plurality of data sets; selecting a texturing image on the basis of the existence of a non-target object from the plurality of data sets, and performing texturing on the three-dimensional mesh model by using the selected texturing image; and providing the textured three-dimensional virtual model to a user through a user interface.

Another technical aspect of the present invention proposes a computing device for generating a three-dimensional virtual model. The computing device includes: at least one processor; and a memory for storing instructions. The instructions, when executed individually or collectively by the at least one processor, cause the processor to generate a three-dimensional mesh model for a real space using a plurality of data sets, select a texturing image based on the presence of a non-target object in the plurality of data sets, perform texturing on the three-dimensional mesh model using the selected texturing image, and provide a user with a three-dimensional virtual model on which texturing is completed through a user interface.

Another technical aspect of the present invention proposes a storage medium. The storage medium is a storage medium storing computer-readable instructions, and the instructions, when executed by a computing device, perform operations of: generating a three-dimensional mesh model for a real space using a plurality of data sets; selecting a texturing image based on the presence of a non-target object from the plurality of data sets, and performing texturing on the three-dimensional mesh model using the selected texturing image; and providing the textured three-dimensional virtual model to a user through a user interface.

The means for solving the above problems do not list all the features of the present invention. Various means for solving the problem of the present invention will be understood in more detail with reference to the detailed embodiments of the following description.

According to the present application, there are one or more of the following effects.

According to an embodiment of the present invention, when a three-dimensional virtual space corresponding to a real space is generated based on photographing data sets collected at various photographing points in the real space, it is possible to prevent a non-target object, which is an unintended object to be scanned, from being textured in advance.

According to an embodiment of the present invention, a non-target object is identified as an object identification target for an image, and color data for an object region of the non-target object is set by replacing a padding value, thereby effectively selecting a texturing image having no non-target object even with a small amount of computation.

According to an embodiment of the present invention, by setting the padding value of the color data of the object region of the non-target object as a penalty point, it is possible to efficiently select an optimal texturing image even when a plurality of non-target objects exist.

The effects of the present application are not limited to the effects mentioned above, and other effects not mentioned will be clearly understood by those skilled in the art from the description of the claims.

### BRIEF DESCRIPTION OF THE DRAWINGS

FIG. 1 is a diagram illustrating a system for providing a three-dimensional virtual model according to an embodiment disclosed in the present application.

FIG. 2 is a diagram for explaining each component of a system for providing a three-dimensional virtual model according to an embodiment disclosed in the present application.

FIG. 3 is a flowchart illustrating a texturing method for generating a 3D virtual model according to an embodiment disclosed in the present application.

FIG. 4 is a flowchart illustrating a method of generating a 3D mesh model according to an embodiment of the present disclosure.

FIG. 5 is a flowchart illustrating a method of selecting a texturing image and performing texturing according to an embodiment disclosed in the present application.

FIG. 6 is a flowchart illustrating an identification processing method for a non-target object according to an embodiment disclosed in the present application.

FIG. 7 is a flowchart illustrating a method of selecting a texturing image according to an embodiment disclosed in the present application.

FIG. 8 is a flowchart illustrating a method of selecting a texturing image according to another embodiment disclosed in the present application.

FIGS. 9 to 10 are diagrams for describing an example of selecting a texturing image based on a non-target object according to an embodiment disclosed in the present application.

FIGS. 11 to 14 are diagrams illustrating examples of texturing results according to an embodiment disclosed in the present application.

FIG. 15 is a diagram illustrating an exemplary structure and operating environment of a computing device according to an embodiment of the present invention.

### DETAILED DESCRIPTION

Hereinafter, embodiments of the present disclosure will be described in detail with reference to the drawings so that those skilled in the art to which the present disclosure pertains can easily implement the present disclosure. However, the present disclosure may be implemented in various different forms and is not limited to the embodiments described herein. In connection with the description of the drawings, the same or similar reference numerals may be used for the same or similar components. In addition, in the drawings and related descriptions, descriptions of well-known functions and configurations may be omitted for clarity and brevity.

It should be understood that various embodiments of the present disclosure and the terms used therein are not intended to limit the technical features described in the present disclosure to specific embodiments, and include various changes, equivalents, or substitutes of the corresponding embodiment. In connection with the description of the drawings, similar reference numerals may be used for similar or related components. The singular form of the noun corresponding to the item may include one or a plurality of the items, unless the relevant context clearly indicates otherwise. In this document, each of the phrases such as “A or B”, “at least one of A and B”, “at least one of A or B”, “A, B or C”, “at least one of A, B, and C”, and “at least one of A, B, or C” may include any one of the items listed together in the corresponding phrase of the phrases, or all possible combinations thereof. Terms such as “first” and “second” may be used to simply distinguish the corresponding elements from other corresponding elements, and the corresponding elements are not limited to other aspects (e.g., importance or order).

The term “module” used in various embodiments of the disclosure may include a unit implemented in hardware, software, or firmware, and may be used interchangeably with terms such as logic, logical blocks, components, or circuits. The module may be a component configured integrally or a minimum unit of the component or a part thereof that performs one or more functions. For example, according to an embodiment, the module may be implemented in the form of an application-specific integrated circuit (ASIC).

Various embodiments of the disclosure may be implemented as software (e.g., a program) including one or more instructions stored in a storage medium (e.g., a memory) readable by a machine or a device. For example, the processor of the appliance or device may call and execute at least one of the one or more instructions stored in the storage medium. This makes it possible for the device to be operated to perform at least one function according to the at least one instruction called. The one or more instructions may include code generated by a compiler or code that may be executed by an interpreter. The machine-readable storage medium may be provided in the form of a non-transitory storage medium. Here, the term “non-transitory” only means that a storage medium is a tangible device and does not include a signal (e.g., electromagnetic waves), and this term does not distinguish between a case in which data is semi-permanently stored in the storage medium and a case in which data is temporarily stored.

According to an embodiment, the method according to various embodiments disclosed in the disclosure may be included in a computer program product and provided. Computer program products may be traded between sellers and buyers as commodities. The computer program product may be distributed in the form of a machine-readable storage medium (e.g., compact disc read only memory (CD-ROM)), or may be distributed (e.g., downloaded or uploaded) online through an application store or directly between two user devices (e.g., smart phones). In the case of online distribution, at least a part of the computer program product may be at least temporarily stored in a machine-readable storage medium such as a server of a manufacturer, a server of an application store, or a memory of a relay server, or may be temporarily generated.

According to various embodiments, each component (e.g., a module or a program) of the above-described components may include a single or a plurality of entities, and some of the plurality of entities may be separately disposed in other components. According to various embodiments, one or more components or operations of the above-described corresponding components may be omitted, or one or more other components or operations may be added. Alternatively or additionally, a plurality of components (e.g., a module or a program) may be integrated into one component. In this case, the integrated component may perform one or more functions of each component of the plurality of components in the same or similar manner as those performed by a corresponding component of the plurality of components before the integration. According to various embodiments, operations performed by a module, a program, or other components may be sequentially, in parallel, repeatedly, or heuristically executed, one or more of the operations may be executed in a different order, omitted, or one or more other operations may be added.

In the present disclosure, the processor may refer to hardware capable of performing functions and operations according to each name described in the present specification, may mean computer program code capable of performing specific functions and operations, or may mean an electronic recording medium having computer program code capable of performing specific functions and operations. According to an embodiment, the operation of the processor may be defined and/or interpreted as the operation of the digital signage content providing apparatus, but is not limited thereto. The processor may mean a functional and/or structural combination of hardware for performing the technical idea of the present disclosure and/or software for driving the hardware.

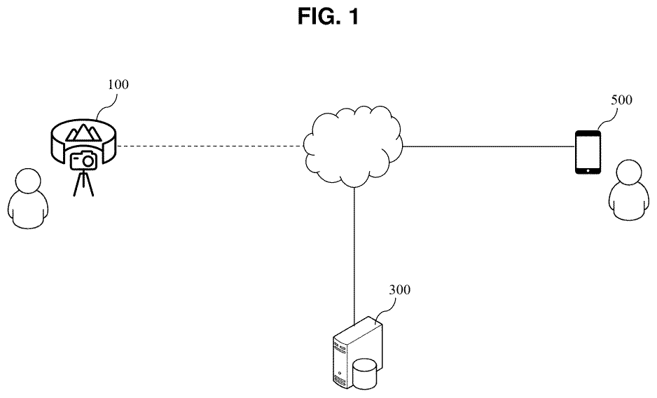

FIG. 1 is a diagram illustrating a system for providing a three-dimensional virtual model according to an embodiment disclosed in the present application.

The system for providing a three-dimensional virtual model may include a scan device 100, a computing device 300, and a user terminal 500.

The scan device 100 is an electronic device for generating a photographing data set at each photographing point in the real space, and is a portable electronic device including a camera and a distance measurement sensor.

The scan device 100 may may perform scanning at each of a plurality of photographing points in the real space to generate a plurality of data sets for the plurality of photographing points in the real space.

The plurality of data sets may include an image and depth data acquired at each photographing point, and may further include indoor location data according to an embodiment.

In an embodiment, the data set generated at each photographing point may be a 360-degree panoramic image acquired at the corresponding photographing point and 360-degree depth data (e.g., Depth map) acquired at the corresponding photographing point.

The computing device 300 may configure a three-dimensional virtual model corresponding to a real space based on a plurality of data sets collected from the scan device 100.

The computing device 300 may receive a plurality of data sets generated at various indoor photographing points from the scan device 100. The computing device 300 may generate a three-dimensional virtual model that is a three-dimensional virtual space corresponding to the real space by using a plurality of data sets, that is, images and depth data generated at various points in the room, respectively.

Here, the image is an expression that encompasses all images expressed in color, and is not limited to an image of a specific expression method. Accordingly, the color image may be applied to various types of images, such as an RFG image represented by Red Green Blue (RGB) and an CMYK image represented by Cyan Magenta Yellow Key (CMYK).

The depth data is an expression encompassing data providing depth information with respect to the scanned space, and for example, each pixel in the depth data may be distance information from a photographing point to each point in the scanned space—to a point in the space corresponding to each pixel.

The computing device 300 may generate a three-dimensional mesh model for the real space based on a plurality of data sets for each of a plurality of photographing points in the real space received from the scan device 100.

Here, the 3D mesh model is a 3D model representing a spatial volume constituting a real space as a set of polygons, and the 3D mesh model may be represented by a plurality of vertices, an edge connecting the two vertices, and a face partitioned by a plurality of edges.

The computing device 300 may map a part of an image onto the surface of the 3D mesh model to perform texturing that is similar to each area of the real space, and may generate a 3D virtual model corresponding to the real space by completing such texturing.

The computing device 300 may provide a three-dimensional virtual space experience corresponding to the real space by providing the generated three-dimensional virtual model to the user terminal 500 or the like.

The user terminal 500 is an electronic device through which a user may experience a three-dimensional virtual model corresponding to a real space. The user may access the computing device 300 using the user terminal 500 and experience the three-dimensional virtual model provided by the computing device 300.

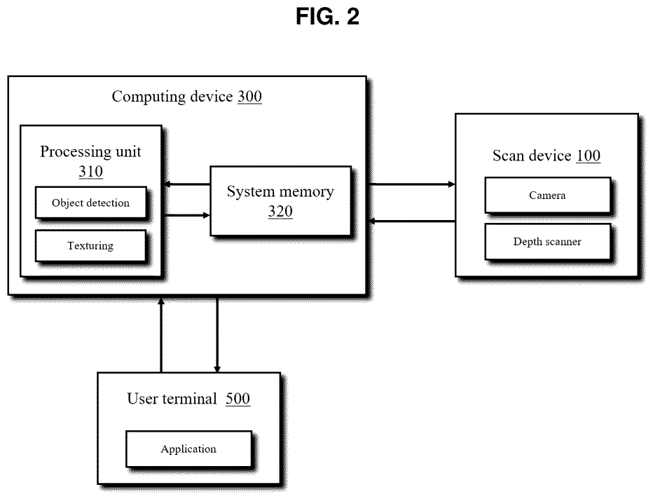

FIG. 2 is a diagram for explaining each component of a system for providing a three-dimensional virtual model according to an embodiment disclosed in the present application.

The computing device 300 may include a processing unit 310 and a system memory 320.

The processing unit 310 may include, for example, at least one of a microprocessor, a central processing unit, a processor core, a multi-core processor, a multi-processor, an application-specific integrated circuit (ASIC), or a field programmable gate array (FPGA), but is not limited thereto.

The computing device 300 may include a module for object detection and a module for performing texturing. These modules may be an artificial intelligence model or software module that operates individually, and may be implemented as a part of the processing unit 310, but are not limited thereto, and a separate processor may be used for each module.

The system memory 320 may store instructions (or programs) executable by the processing unit 310. The system memory 320 may include a volatile memory or a nonvolatile memory. The volatile memory may be implemented as a dynamic random access memory (DRAM), a static random access memory (SRAM), a thyristor RAM (T-RAM), a zero capacitor RAM (Z-RAM), or a twin transistor RAM (TTRAM). The nonvolatile memory may be implemented as an electrically erasable programmable read-only memory (EEPROM), flash memory, magnetic RAM (MRAM), spin transfer torque MRAM (STT-MRAM), Conductive Bridging RAM (CBRAM), ferroelectric RAM (FeRAM), phase change RAM (PRAM), resistive RAM (RRAM), nanotube RRAM, polymer RAM (PoRAM), Nano floating gate memory (NFGM), holographic memory, molecular electronic memory device, or an insulator resistance change memory.

The computing device 300 may be implemented as a server, but is not limited thereto.

The scan device 100 includes a camera for acquiring an image and a depth scanner for acquiring depth data.

The depth scanner may include a predetermined sensor for distance measurement, for example, a LiDAR sensor, an infrared sensor, an ultrasonic sensor, and the like. Alternatively, in order to acquire depth data, the depth scanner may include a stereo camera, a stereoscopic camera, a 3D depth camera, and the like capable of measuring distance information by replacing a sensor.

The user terminal 500 is a device used by a user, and the user may be connected to the computing device 300 through the user terminal 500.

The user terminal 500 is an electronic device in which software such as an application is driven, and may be, for example, a mobile phone, a smart phone, a laptop computer, a digital broadcasting terminal, a personal digital assistants (PDA), a portable multimedia player (PMP), a navigation system, a personal computer (PC), a tablet PC, an ultrabook, a wearable device, for example, a watch-type terminal (smartwatch), a glass-type terminal (smart glass), a head mounted display (HMD), a virtual reality (VR) device, or an augmented reality (AR) device.

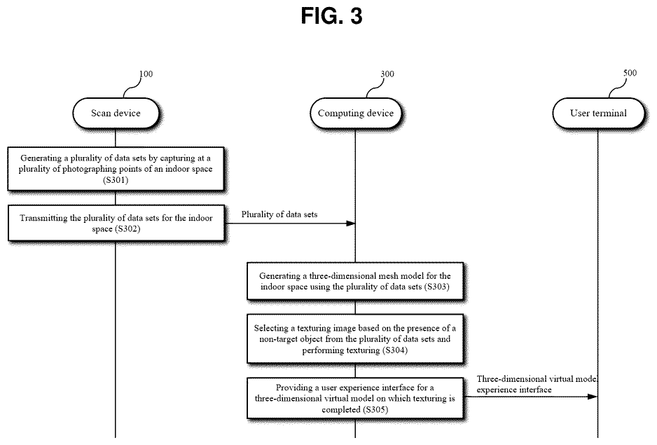

FIG. 3 is a flowchart illustrating a texturing method for generating a 3D virtual model according to an embodiment disclosed in the present application.

The scan device 100 may generate a plurality of data sets by photographing at a plurality of photographing points in the real space (S301). That is, the scan device 100 may generate one data set for each photographing point in the real space.

For example, the data set may include a 360-degree panoramic image acquired at a corresponding photographing point and 360-degree depth data acquired at a corresponding photographing point. According to an embodiment, the data set may further include location information data for a corresponding photographing point, for example, SLAM (Simultaneous Localization and Mapping).

The scan device 100 may transmit a plurality of data sets for the real space to the computing device 300 (S302).

The computing device 300 may receive a plurality of data sets from the scan device 100 and generate a 3D mesh model, which is a 3D space model corresponding to the real space, by using the plurality of data sets (S303).

For example, the computing device 300 may generate a plurality of point clouds in a 3D space by arranging a plurality of data sets respectively corresponding to a plurality of photographing points in a real space on the 3D space, and generate a 3D mesh model based on the point clouds.

The computing device 300 may generate a 3D virtual model by performing texturing on the generated 3D mesh model (S304).

In performing texturing, the computing device 300 may perform texturing in consideration of a non-target object. Here, the non-target object refers to an object that does not correspond to spatial information of the real space when virtualization for the real space is configured, and may correspond to, for example, a human object.

That is, the computing device 300 may select a texturing image based on the existence of a non-target object from a plurality of data sets, and may perform texturing on the 3D mesh model using the selected texturing image (S304).

As described above, by performing texturing in consideration of the non-target object, the non-target object is not projected onto the texture represented in the 3D virtual model, thereby improving the texturing quality of the 3D virtual model.

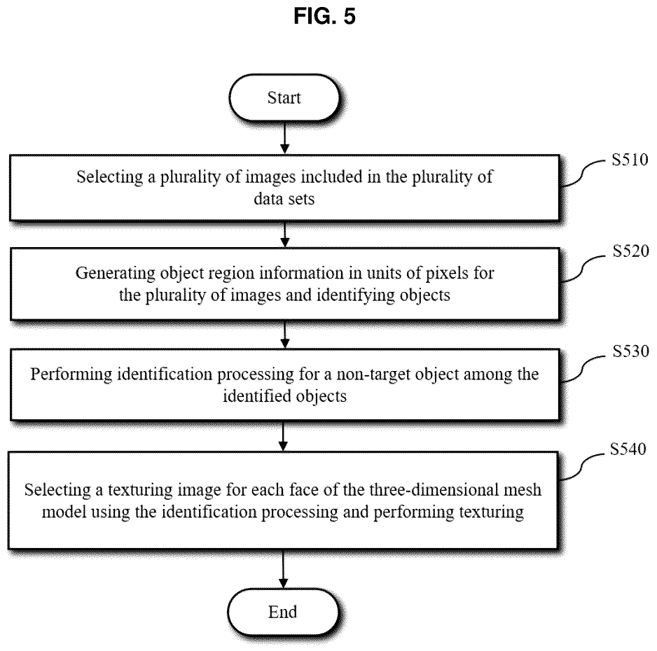

Various embodiments of performing texturing in consideration of such a non-target object will be described in more detail below with reference to FIGS. 5 to 8.

The computing device 300 may provide a user experience interface to the user terminal 500 with respect to the textured 3D virtual model to provide the user with an experience of the 3D virtual space corresponding to the real space (S305). As the experience interface, various viewers based on virtual reality (VR) may be applied.

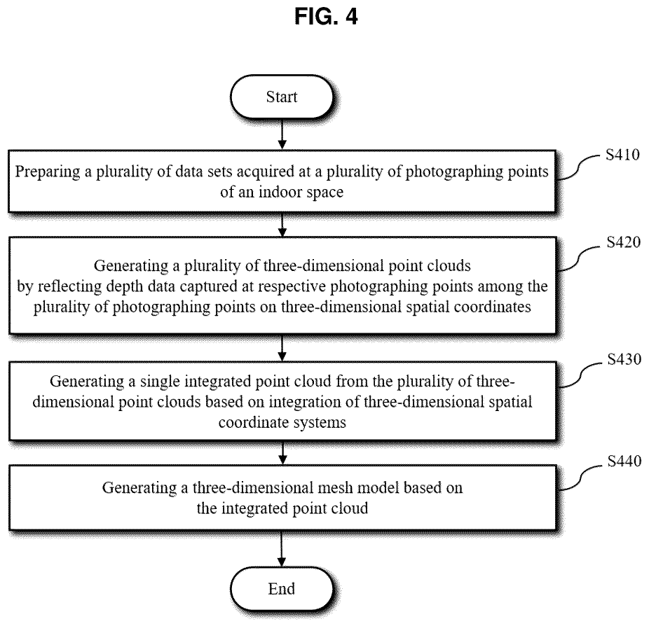

FIG. 4 is a flowchart illustrating a method of generating a 3D mesh model according to an embodiment of the present disclosure.

Referring to FIG. 4, the computing device 300 may prepare a plurality of data sets acquired at a plurality of photographing points in a real space (S410).

The computing device 300 may generate a plurality of 3D point clouds by reflecting depth data captured at a plurality of photographing points on the 3D spatial coordinates (S420).

For example, the computing device 300 may individually set 3D spatial coordinates for each photographing point and reflect a data set at the corresponding photographing point to the individual 3D spatial coordinates to generate a point cloud for each photographing point.

For example, the computing device 300 may generate one integrated point cloud from a plurality of three-dimensional point clouds based on the integration of the three-dimensional spatial coordinate system (S430).

Thereafter, the computing device 300 may generate an integrated point cloud based on the integrated 3D spatial coordinates for the real space by reflecting the point cloud of the individual 3D spatial coordinates generated at each photographing point in one integrated 3D spatial coordinate based on the location information of each photographing point. The computing device 300 may perform normalization of the point cloud for such integration, and may perform processing for duplexing of the point cloud according to the integration of several coordinates.

The computing device 300 may generate a 3D mesh model based on the integrated 3D spatial coordinate-based point cloud as described above (S440).

For example, the computing device 300 may select a plurality of vertices based on the point cloud, form edges between the plurality of vertices, and then set a plurality of faces based on the edges to generate a 3D mesh model.

For example, the computing device 300 may generate one face based on three adjacent vertices, and in this case, the face may be a flat triangle set to three vertices. As another example, a rectangular face may be set based on four vertices.

FIG. 5 is a flowchart illustrating a method of performing texturing by selecting a texturing image according to an embodiment disclosed in the present application.

Referring to FIG. 5, the computing device 300 may select a plurality of images included in a plurality of data sets (S510). Since the 3D mesh model is a model in a state in which there is no texture on the surface of a face, in order to perform texturing on such a face, an image related to the corresponding face must be selected. That is, since the source of texturing is an image, the computing device 300 may select an image from the data set for texturing.

The computing device 300 may identify an object in the image. That is, the computing device 300 may generate object area information of a pixel unit for a plurality of images to identify an object (S520).

In an embodiment, the computing device 300 may use a deep learning model to identify an object in an image. For example, the computing device 300 may identify the object in the image by using a semantic segmentation deep learning model that processes a segmentation operation of determining whether each pixel belongs to a specific object in the image or video.

Such a semantic segmentation deep learning model may include a backbone, upsampling, and mask prediction. The back process is a process of extracting main features from an input image using a feature extractor such as VGG or ResNet. Since the semantic segmentation deep learning model mainly uses a feature map in which an image size is reduced, as a result, a process of restoring the original image size through upsampling is required, and in this upsampling process, prediction in units of pixels may be performed. Thereafter, the semantic segmentation deep learning model may process a process of predicting not only a bounding box but also a mask of a corresponding object for each object, thereby dividing an accurate shape of the object.

As such a semantic segmentation deep learning model, FCN (Fully Convolutional Networks), U-Net, DeepLab models, and the like may be applied, but are not limited thereto.

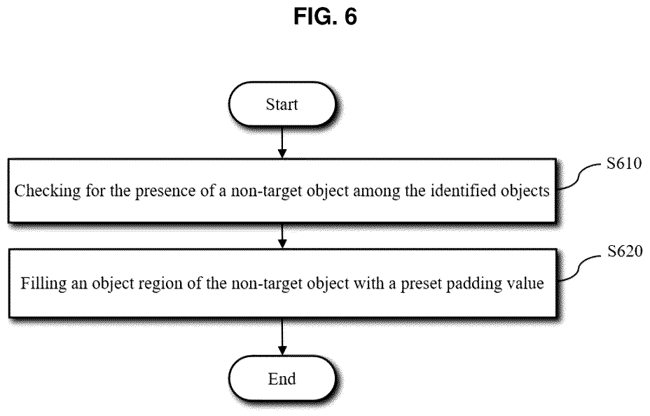

The computing device 300 may perform identification processing on a non-target object among the identified objects as described above (S530). For example, the computing device 300 may select a non-target object from among the identified objects, and may perform separate identification processing on the selected region of the non-target object. An example of such an identification process will be described below with reference to FIG. 6.

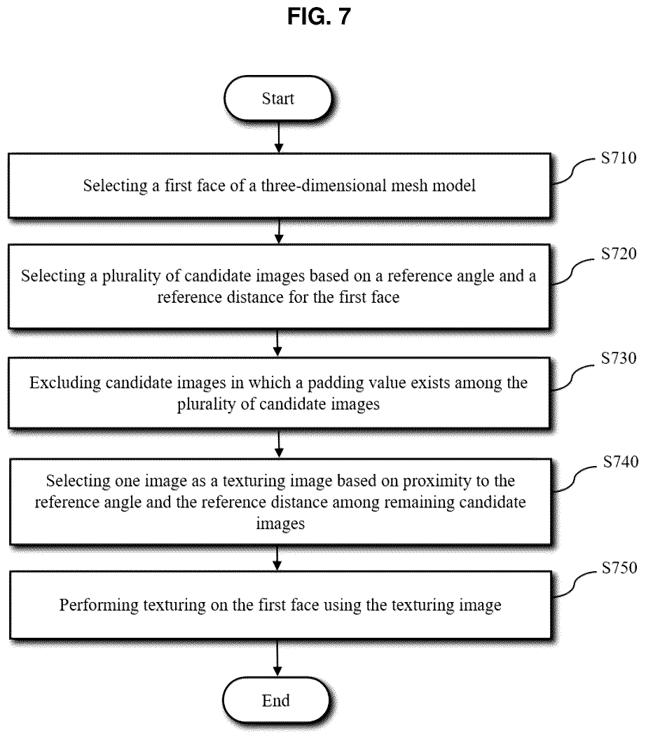

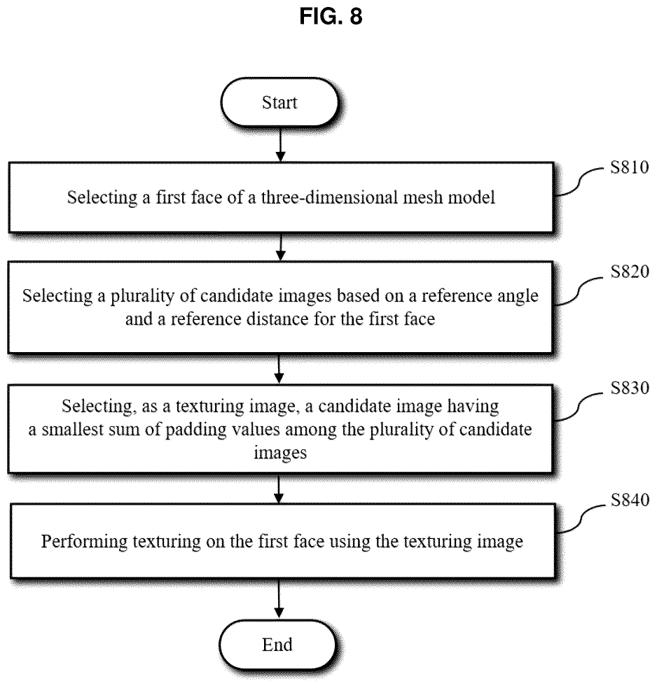

The computing device 300 may perform texturing by selecting a texturing image for each face of the 3D mesh model based on the above identification process (S540). Various examples of such identification processing will be described below with reference to FIGS. 7 to 8.

As described above, the computing device 300 may identify the non-target object in the image and perform separate identification processing on the area of the non-target object, thereby quickly identifying the non-target object in the texturing process using the image to select an image having no non-target object or having the smallest non-target object as the texturing image.

FIG. 6 is a flowchart illustrating an identification processing method for a non-target object according to an embodiment disclosed in the present application. FIG. 6 illustrates an embodiment of identification processing for a non-target object in step S530 shown in FIG. 5.

Referring to FIG. 6, the computing device 300 may identify the existence of a non-target object among the identified objects (S610). For example, the computing device 300 may identify a human object that is a non-target object among various types of objects identified in the image.

The computing device 300 may perform padding processing to fill the object area of the non-target object with a preset padding value (S620).

For example, the computing device 300 may set a padding value for each pixel of the object area of the non-target object. That is, the padding value may be set by replacing the color value of each pixel of the image.

Here, the object area of the non-target object is an area in which the non-target object is displayed in the image, and for example, when an upper body of a person exists in the image, all of the upper body areas of the person may be the object area.

In an embodiment, the padding value may be a preset penalty value. Such a penalty value may be used in an evaluation process for a candidate image to be described later, and for example, a candidate image having a small penalty value may be used in a manner in which the candidate image is set as a texturing image.

In an embodiment, the padding value may be a preset null value. In this case, since the null value does not have any value, even if it is used for texturing, it may be expressed in a hole shape that does not include any texture. In this case, also, a candidate image having no null value or less may be used in a manner of being set as a texturing image.

This padding processing process may be performed in various steps according to embodiments. As an example, FIG. 5 illustrates an embodiment in which all padding processing on a non-target object is performed on a plurality of images, but is not limited thereto. That is, after selecting candidate images to be described later for each face, various modifications may be performed, such as performing padding processing on a non-target object based on the candidate images.

FIG. 7 is a flowchart illustrating a method of selecting a texturing image according to an embodiment disclosed in the present application.

FIG. 7 illustrates an example of a process of performing texturing by selecting a texturing image for each face in a 3D mesh model as an example of operation S540 illustrated in FIG. 5.

Referring to FIG. 7, the computing device 300 may select a first face that is any one face in the 3D mesh model (S710).

The computing device 300 may select a plurality of candidate images based on the reference angle and the reference distance for the first face (S720).

For example, the computing device 300 may set a predetermined reference angle with respect to the normal vector for the first face, and set a predetermined distance from the first face as a reference distance. The computing device 300 may calculate the angle and distance of each image with respect to the first face based on the camera pose and position for each image. The computing device 300 may set images satisfying the reference angle and the reference distance as a plurality of candidate images.

In the above example, an example of setting the candidate image based on the reference angle and the reference distance has been described, but this is exemplary, and the candidate image may be set based on the reference angle or the reference distance.

In an embodiment, the computing device 300 may actively change and set the reference angle or the reference distance such that the number of candidate images is equal to or greater than a predetermined number. That is, when the number of candidate images is set to a minimum of 5 or more and the number of images satisfying the preset reference angle and reference distance is less than 5, the computing device 300 may actively set the reference angle or reference distance to be changed-large so that the number of candidate images satisfying the reference angle and the reference distance satisfies at least 5.

The computing device 300 may determine whether there is a padding value for the plurality of candidate images based on whether there is the padding value, and may exclude the candidate image in which the padding value exists (S730).

Step S730 is a process of excluding an image in which the non-target object is displayed from the candidate image, and through this, the non-target object is processed so as not to exist in the finally selected texturing image.

The computing device 300 may select one image as a texturing image based on the proximity to the reference angle and the reference distance for the remaining candidate images remaining after the exclusion processing (S740).

Various methods may be applied to select any one of the candidate images as a texturing image. For example, an image having the smallest value of the reference angle and an area in which the corresponding face is displayed having a predetermined size or more may be selected as the final texturing image. Another example is that an image having the highest resolution for the corresponding face—for example, the largest area size—may be selected as the texturing image. In addition, various methods for selecting a final texturing image are applicable.

Thereafter, the computing device 300 may perform texturing processing on the first face using the selected texturing image. For example, a region corresponding to the first face in the selected texturing image may be selected and projected onto the first face to perform texturing. Since various methods may be applied to the texturing method for such a face, the description thereof will be omitted here.

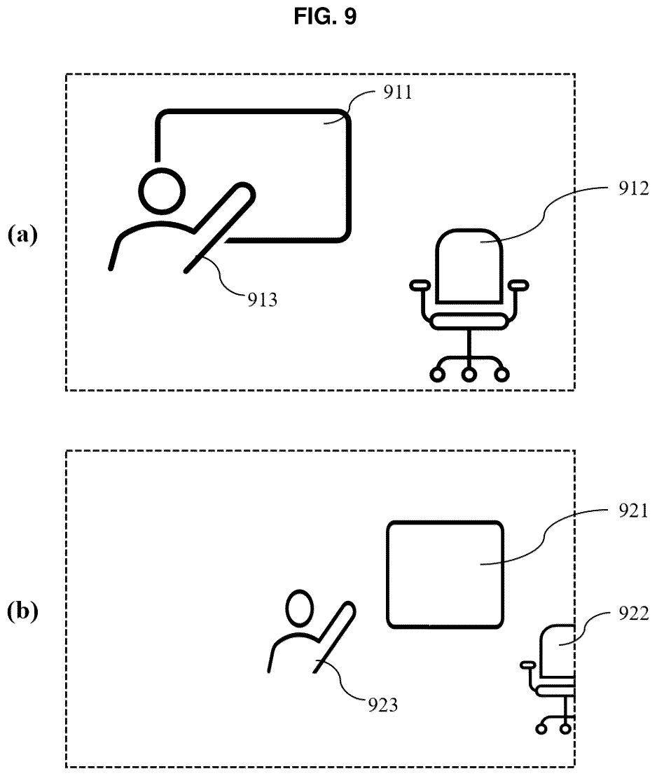

FIG. 9 illustrates such an example. In FIG. 9, pictures (a) and (b) are illustrated as candidate images for a blackboard object face. Figure (a) is an image taken from the front of the blackboard, and the reference angle corresponds to the normal buck and has the highest score for the reference angle, and the resolution of the blackboard object is higher than that of Figure (b), so the score for the reference distance is also higher. On the other hand, Figure (b) is an image taken a little farther from the left side of the blackboard, and has a worse score than Figure (a) based on the reference angle and reference distance.

On the other hand, although the blackboard object 911 and the non-target object 913 are displayed together in the figure (a), only the blackboard object 921 is displayed in the figure (b). Accordingly, in this case, in the blackboard object face, the blackboard object face may be selected as the texturing image in the picture (b) in which there is no non-target object.

If the face to be textured is for the chair object, since the chair object 912 in the figure (a) is superior to the chair object 922 in the figure (b) at the reference angle and/or the reference distance, the figure (a) may be selected as the texturing image for the chair object face.

FIG. 8 is a flowchart illustrating a method of selecting a texturing image according to another embodiment disclosed in the present application.

FIG. 8 illustrates another example of a process of performing texturing by selecting a texturing image for each face in a 3D mesh model as another example of operation S540 illustrated in FIG. 5.

Referring to FIG. 8, the computing device 300 may select a first face of the 3D mesh model (S810), and may select a plurality of candidate images based on a reference angle and a reference distance for the first face (S820). The computing device 300 may select a candidate image having the smallest sum of padding values for the plurality of candidate images as the texturing image (S830). The computing device 300 may perform texturing on the first face using the selected texturing image (S840).

The example illustrated in FIG. 8 relates to an embodiment of selecting a candidate image based on a sum of padding values of a non-target object, and in this case, relates to an embodiment in which a padding value of a non-target object is used as a penalty, that is, a subtraction element.

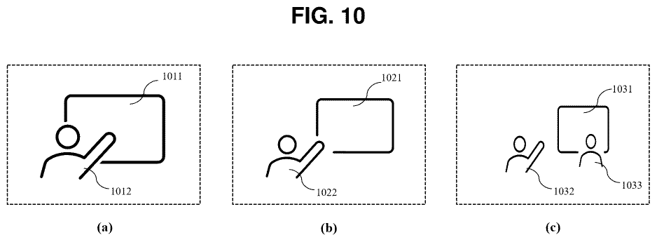

FIG. 10 illustrates this example. In FIG. 10, figures (a), (b), and (c) are illustrated as candidate images for a blackboard object face. Figure (a) is an image taken from the front of the blackboard, and the reference angle corresponds to the normal buck and has the highest score for the reference angle, and the resolution for the blackboard object is also high, so the score for the reference distance is higher. On the other hand, figure (b) is an image taken a little far from the left side of the blackboard, and has a worse score than figure (a) based on the reference angle and reference distance. Figure (c) is an image taken a little farther from the left side of the blackboard, and has a worse score than figure (a) and figure (b) when based on the reference angle and reference distance.

On the other hand, in the figure (a), the blackboard object 1011 and the non-target object 1013 are displayed together, and the area of the non-target object 1013 is the largest hidden. In figure (b), the area of the non-target object 1022 overlapping the blackboard object 1021 is the smallest. In figure (c), the first non-target object 1032 does not overlap the blackboard object 1031, but the area taken by the second non-target object 1033 is the second largest.

Accordingly, since the penalty is increased by the size of the area corresponding to the non-target object, in this case, the figure (b) for the blackboard object face will be selected as the texturing image.

In the above descriptions, a blackboard object has been described as one face, but this is for convenience of description and is not limited thereto. That is, in practice, the blackboard object may include a plurality of polygons, for example, a plurality of triangular faces, and the processing of FIG. 7 or FIG. 8 will be performed individually for each face. That is, the presence or padding value of the non-target object may be individually processed for each face.

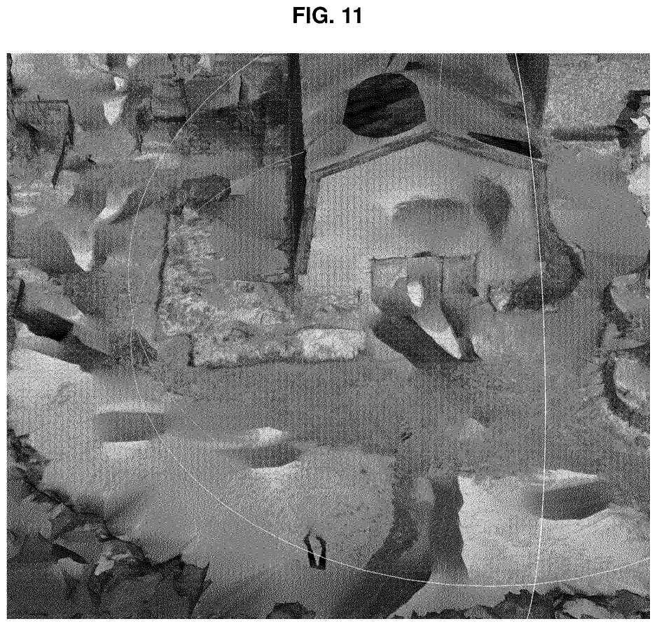

FIGS. 11 to 14 are diagrams illustrating examples of texturing results according to an embodiment disclosed in the present application.

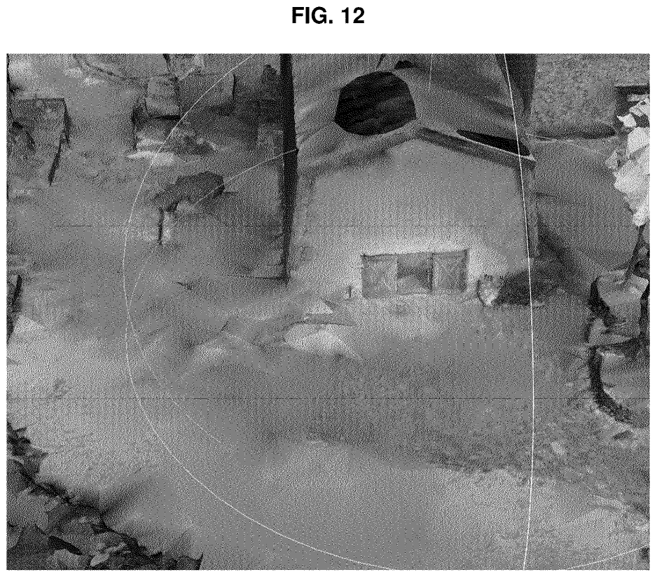

In FIG. 11, as an example of a general texturing method before the present invention is applied, it can be seen that a human shape is textured on the outer wall of a building. On the other hand, FIG. 12 is an example of applying an embodiment of the present invention to the same data set, and it can be seen that a human object is not textured at all on the outer wall of a building or the like.

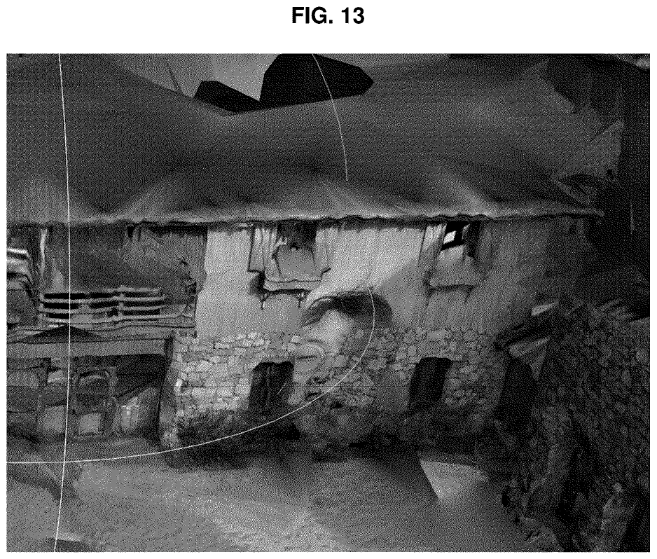

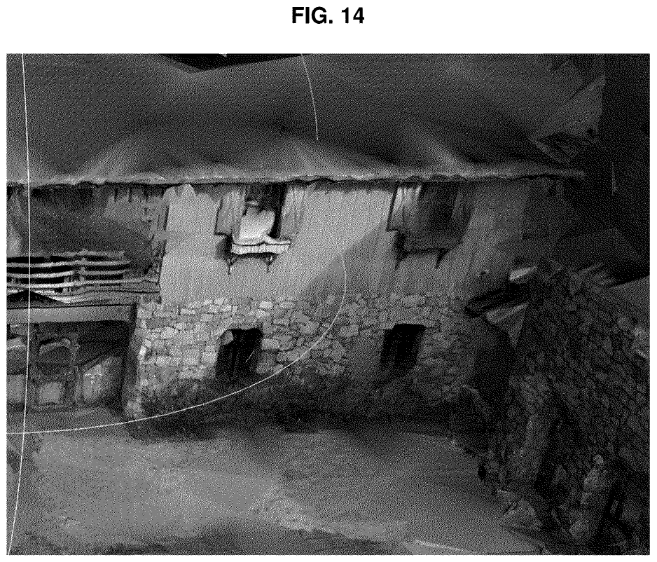

FIG. 13 is also an example of a general texturing method before the present invention is applied, and it can be seen that a shape of a person is textured on some faces of a building wall surface. On the other hand, FIG. 14 is an example of applying an embodiment of the present invention to the same data set, and it can be seen that a human object is not textured at all on the outer wall of a building.

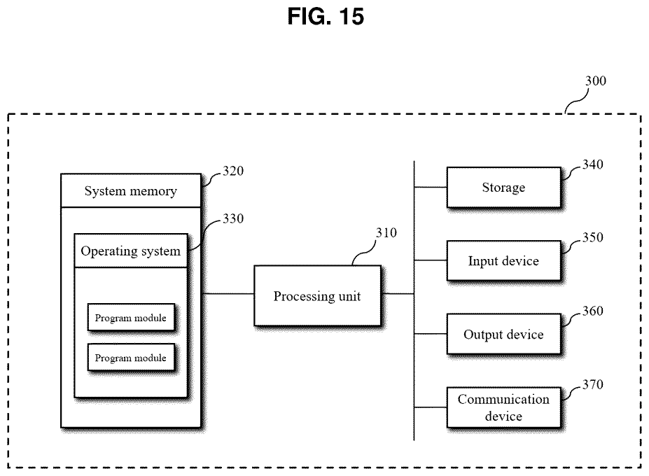

FIG. 15 is a diagram illustrating an exemplary environment of a computing device according to an embodiment of the present invention.

FIG. 15 is for providing a general and simplified description of a suitable computing environment in which various embodiments of a computing device may be implemented, and with reference to FIG. 14, a computing device 100 is shown.

The computing device 100 may include at least a processing unit 310 and a system memory 320.

The computing device may include a plurality of processing units that cooperate when executing a program. Depending on the exact configuration and type of computing device, system memory 301 may be volatile (e.g., RAM), non-volatile (e.g., ROM, flash memory, etc.), or a combination thereof. The system memory 320 includes a suitable operating system 330 for controlling the operation of the platform, which may be, for example, an WINDOWS operating system from Microsoft. The system memory 320 may include one or more software applications, such as program modules, applications, and the like.

The computing device may include additional data storage devices 340 such as magnetic disks, optical disks, or tapes. Such additional storage may be removable storage and/or fixed storage. Computer-readable storage media may include volatile and non-volatile, removable and stationary media embodied in any method or technique for storage information, such as computer-readable instructions, data structures, program modules, or other data. Both the system memory 320 and the data storage device 340 are examples of computer-readable storage media. The computer-readable storage medium may include, but is not limited to, RAM, ROM, EEPROM, flash memory or other memory technique, CD-ROM, DVD or other optical storage, magnetic tape, magnetic disk storage or other magnetic storage device, or any other medium capable of storing desired information and being accessed by the computing device 100.

The input device 350 of the computing device may include, for example, a keyboard, a mouse, a pen, a voice input device, a touch input device, and a comparable input device. The output device 360 may include, for example, a display, a speaker, a printer, and other types of output devices. These devices are well known in the art, and thus a detailed description thereof will be omitted.

The computing device may include, for example, a communication device 370 that allows the device to communicate with other devices via a network in a distributed computing environment, such as a wired/wireless network, a satellite link, a cellular link, a local area network, and a comparable mechanism. The communication device 370 is one example of a communication medium, which may include computer readable instructions, data structures, program modules, or other data therein. For example, the communication medium includes wired media such as a wired network or direct connection, and wireless media such as acoustic, RF, infrared, and other wireless media, but is not limited thereto.

As described above, although the embodiments have been described with reference to the limited embodiments and drawings, those skilled in the art may make various modifications and modifications from the above description. For example, appropriate results may be achieved even if the described techniques are performed in a different order than the described method, and/or if components of the described system, structure, apparatus, circuit, etc. are combined or combined in a different form than the described method, or replaced or substituted by other components or equivalents.

Therefore, other implementations, other embodiments, and equivalents of the claims are within the scope of the claims to be described later.

As described above, although the detailed description of the present document has been described with respect to specific embodiments, it will be obvious to a person skilled in the art that various modifications are possible without departing from the scope of the present document.

According to an embodiment of the present invention, when a three-dimensional virtual space corresponding to a real space is generated based on photographing data sets collected at various photographing points in the real space, there is an effect of preventing texturing of a non-target object, which is an unintended subject, in advance, and thus there is a high possibility of industrial use.

In addition, since a non-target object is identified as an object identification target for an image, and color data for an object region of the non-target object is set by replacing a padding value, it is possible to efficiently select a texturing image without a non-target object even with a small amount of computation, thereby having high industrial applicability.

In addition, since the padding value is set as a penalty for the color data of the object region of the non-target object, it is possible to efficiently select an optimal texturing image even when a plurality of non-target objects exist, and thus, it is highly likely to be used in industry.

### REFERENCE

The present invention has been applied overseas with the support of the following research projects supported by the Korean government.

### Assignment 1

Assignment Number: 20023322
Ministry name: Ministry of Trade, Industry and Energy;
An institution specializing in research and management: The Korea Evaluation Institute of Industrial Technology;
Research Project Name: Excellent Enterprise Research Institute Fostering Project (ATC+)
Research Project Name: Advanced Intelligent Digital Twin Service Platform Based on Converged Visual Localization Algorithm Supporting Various Types of Data Collected
Managing Authority: Triai Co., Ltd.
Research period: 2024.01.01˜2024.12.31

### Assignment 2

Assignment Identification Number: 2710006711
Assignment Number: 00229330
Ministry name: Ministry of Science and ICT
Task Management (Specialized) Agency: Information and Communications Planning Evaluation Institute;
Research Project Name: Development of Realistic Core Contents
Title of Research: Streaming 3D Digital Media Service Technology
Name of the institution performing the task: Seoul National University of Science and Technology Industry-Academic Cooperation Foundation;
Research period: 2024.01.01˜2024.12.31

What is claimed is:

1. A texturing method performed in a computing device that generates a three-dimensional virtual model for a real space based on a plurality of data sets generated at a plurality of photographing points of the real space, the method comprising:
generating a three-dimensional mesh model for the real space using a plurality of data sets;
selecting a texturing image based on the presence of a non-target object from the plurality of data sets, and performing texturing on the three-dimensional mesh model using the selected texturing image; and
providing a user with the textured three-dimensional virtual model through a user interface.

2. The texturing method of claim 1, wherein the plurality of data sets comprises
a 360-degree panoramic image acquired at a photographing point; and
360-degree depth data acquired at the photographing point.

3. The texturing method of claim 1, wherein the performing of the texturing on the 3D mesh model using the texturing image comprises:
identifying an object by generating object area information in units of pixels for a plurality of images included in the plurality of data sets;
selecting a non-target object from among the identified objects and performing identification processing; and
selecting a texturing image for each face of the 3D mesh model based on the identification processing.

4. The texturing method of claim 3, wherein the identification process is performed by replacing color data of the object region of the non-target object with a preset padding value.

5. The method of claim 4, wherein the selecting of the texturing image for each face of the 3D mesh model based on the identification process comprises:
selecting a first face of the 3D mesh model;
selecting a plurality of candidate images based on a reference angle and a reference distance with respect to the first face; and
excluding candidate images having the padding value from the plurality of candidate images.

6. The texturing method of claim 5, wherein the selecting of the texturing image for each face of the 3D mesh model based on the identification process further comprises selecting one image as a texturing image based on a reference angle and proximity to a reference distance for the remaining candidate images.

7. The texturing method of claim 4, wherein the selecting of the texturing image for each face of the 3D mesh model based on the identification process comprises:
selecting a first face of the 3D mesh model; selecting a plurality of candidate images based on a reference angle and a reference distance with respect to the first face; and
selecting a candidate image having a smallest sum of padding values among the plurality of candidate images as the texturing image.

8. A computing device for generating a three-dimensional virtual model, the computing device comprising:
at least one processor; and
a memory configured to store instructions, wherein the instructions, when executed individually or collectively by the at least one processor, cause the processor to:
generate a three-dimensional mesh model for a real space using a plurality of data sets;
select a texturing image based on the presence of a non-target object from the plurality of data sets, and perform texturing on the three-dimensional mesh model using the selected texturing image; and
provide the textured three-dimensional virtual model to a user through a user interface.

9. The computing device of claim 8, wherein the plurality of data sets comprises:
a 360-degree panoramic image acquired at a photographing point; and
360-degree depth data acquired at the photographing point.

10. The computing device of claim 8, wherein the computing device is further configured to:
in order to perform texturing on the 3D mesh model using the texturing image, for a plurality of images included in the plurality of data sets,
identify an object by generating object area information in units of pixels,
select a non-target object from among the identified objects, perform identification processing, and
select a texturing image for each face of the 3D mesh model based on the identification processing.

11. The computing device of claim 10, wherein the identification processing is padded by replacing color data for an object region of the non-target object with a preset padding value.

12. The computing device of claim 11, wherein the computing device is further configured to:
in order to select a texturing image for each face of the three-dimensional mesh model based on the identification process,
selects a first face of the three-dimensional mesh model,
selects a plurality of candidate images based on a reference angle and a reference distance for the first face,
except for the candidate images in which the padding value exists for the plurality of candidate images, and
selects one image as a texturing image based on a proximity to the reference angle and the reference distance for the remaining candidate images.

13. The computing device of claim 11, wherein the computing device is further configured to:
in order to select a texturing image for each face of the three-dimensional mesh model based on the identification process,
selects a first face of the three-dimensional mesh model,
selects a plurality of candidate images based on a reference angle and a reference distance for the first face, and
selects a candidate image having a smallest sum of padding values among the plurality of candidate images as a texturing image.

14. A storage medium storing computer-readable instructions, wherein the instructions, when executed by a computing device, cause the computing device to perform:
generating a three-dimensional mesh model for a real space using a plurality of data sets;
selecting a texturing image based on the presence of a non-target object from the plurality of data sets, and performing texturing on the three-dimensional mesh model using the selected texturing image; and
providing a user with a three-dimensional virtual model on which texturing is completed through a user interface.
